(19) United States
(12) Patent Application Publication
(10) Pub. No.: US 2025/0253450 A1
(43) Pub. Date: Aug. 7, 2025

(54) ENCLOSURE FOR BATTERY CELL INCLUDING QUENCH HARDENED STEEL

(71) Applicant: GM GLOBAL TECHNOLOGY OPERATIONS LLC, Detroit, MI (US)

(72) Inventors: Zhou Wang, Shanghai (CN); Diptak Bhattacharya, Royal Oak, MI (US); Jianfeng Wang, Nanjing (CN)

(21) Appl. No.: 18/641,699

(22) Filed: Apr. 22, 2024

(30) Foreign Application Priority Data
Feb. 1, 2024 (CN) 202410143475X

(51) Int. Cl. H01M 50/119; B23K 31/02; B23K 101/34; B23K 103/04; C21D 1/18; C21D 6/00; C21D 8/10; C21D 9/08; C22C 38/02; C22C 38/04; C22C 38/22; C22C 38/24; C22C 38/26; C22C 38/28; C22C 38/34; C22C 38/38; H01M 50/103; H01M 50/107; H01M 50/124; H01M 50/131; H01M 50/134

(52) U.S. Cl. CPC H01M 50/119; B23K 31/027; C21D 1/18; C21D 6/002; C21D 6/005; C21D 6/008; C21D 8/105; C21D 9/08; C22C 38/02; C22C 38/04; C22C 38/22; C22C 38/24; C22C 38/26; C22C 38/28; C22C 38/34; C22C 38/38; H01M 50/103; H01M 50/107; H01M 50/1245; H01M 50/131; H01M 50/134; B23K 2101/34; B23K 2103/04; C21D 2211/008

(57) ABSTRACT

A method for manufacturing a tubular enclosure for a battery cell includes roll forming a sheet of steel into a tubular body. The steel comprises carbon in a range from 0.02 to 0.3 wt %, manganese in a range from 0.2 to 2.0 wt %, at least one of chromium and molybdenum in a range from 0.5 wt % to 3.0 wt %, silicon in a range from 0.2 wt % to 2.0 wt %, at least one of niobium, titanium, and vanadium in a range from 0.01 wt % to 0.2 wt %, and iron. The method includes welding sides of the tubular body to form a weld seam, heating the tubular body to a temperature in a range from 900° C. to 950° C., and quenching the tubular body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to enclosures for battery cells including quench hardened steel.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators arranged in a battery cell enclosure. The cathode electrodes include a cathode active material layer arranged on a cathode current collector. The anode electrodes include an anode active material layer arranged on an anode current collector.

### SUMMARY

A method for manufacturing a tubular enclosure for a battery cell includes roll forming a sheet of steel into a tubular body. The steel comprises carbon in a range from 0.02 to 0.3 wt %, manganese in a range from 0.2 to 2.0 wt %, at least one of chromium and molybdenum in a range from 0.5 wt % to 3.0 wt %, silicon in a range from 0.2 wt % to 2.0 wt %, at least one of niobium, titanium, and vanadium in a range from 0.01 wt % to 0.2 wt %, and iron. The method includes welding sides of the tubular body to form a weld seam, heating the tubular body to a temperature in a range from 900° C. to 950° C., and quenching the tubular body.

In other features, the method includes one of mechanically crimping and welding a bottom portion onto one end of the tubular body. The tubular body has a martensite microstructure after the quenching. The tubular body includes one or more chromium carbides having a size in a range from 50 to 500 nm.

In other features, a fraction of the one or more chromium carbides in the tubular body is in a range from 1.0 vol % to 20 vol % after the quenching. A weight of the one or more chromium carbides in the tubular body is in a range from 5 wt % to 52 wt % after the quenching. The tubular body has a minimum tensile strength of 800 MPa at room temperature and a minimum tensile strength of 300 MPa at 600° C. The tubular enclosure has one of a cylindrical cross section and a prismatic cross section.

In other features, a maximum hardness difference between a weld seam and steel of the tubular body that was not heat affected during welding is less than 50 HV. The steel includes a nickel coating and an iron-nickel alloy layer arranged between the nickel coating and the steel after the quenching.

A tubular enclosure for a battery cell includes a tubular body made of a steel and including a seam weld. The steel comprises carbon in a range from 0.02 to 0.3 wt %, manganese in a range from 0.2 to 2.0 wt %, chromium and molybdenum in a range from 0.5 wt % to 3.0 wt %, silicon in a range from 0.2 wt % to 2.0 wt %, at least one of niobium, titanium, and vanadium in a range from 0.01 wt % to 0.2 wt %, and iron. A bottom portion is attached to one end of the tubular body.

In other features, the tubular body has a martensite microstructure after austenitizing and quenching. The tubular body includes one or more chromium carbides having a size in a range from 50 to 500 nm after the austenitizing and quenching.

In other features, a fraction of the one or more chromium carbides in the tubular body is in a range from 1.0 vol % to 20 vol % after the austenitizing and quenching. A weight of the one or more chromium carbides in the tubular body is in a range from 5 wt % to 52 wt % after the austenitizing and quenching. The tubular body has a minimum tensile strength of 800 MPa at room temperature and a minimum tensile strength of 300 MPa at 600° C. The tubular enclosure has a prismatic cross section.

In other features, the tubular enclosure has a cylindrical cross section. A maximum hardness difference between the seam weld and steel of the tubular body that was not heat affected during welding is less than 50 HV. The steel includes a nickel coating and an iron-nickel diffusion layer arranged between the nickel coating and the steel.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including a battery cell stack including anode electrodes, cathode electrodes, and separators arranged in an enclosure according to the present disclosure;

FIGS. 2A and 2B are perspective views of examples of prismatic battery cell enclosures according to the present disclosure; and

FIG. 3 is a side cross section of an example of a cylindrical battery cell according to the present disclosure;

FIG. 4A is a side view of an example of a tube during induction welding according to the present disclosure;

FIG. 4B is a side view of an example of a welded tube during induction heating according to the present disclosure;

FIG. 5 is a flowchart of an example of a method for manufacturing a tubular enclosure according to the present disclosure;

FIG. 6A is a scanning electron microscope image of an example of the tubular enclosure before hardening;

FIGS. 6B and 6C are scanning electron microscope images of an example of the tubular enclosure after hardening;

FIGS. 7A and 7B are simulations indicating estimated volume fractions of phases as a function of temperature for an example of the enclosure according to the present disclosure;

FIGS. 8A and 8B are side cross sections showing nickel plated steel before and after hardening according to the present disclosure; and

FIGS. 9A, 9B and 9C illustrate improvements in weld quality after welding, after heating to austenitization, and after quench hardening, respectively according to the present disclosure.

In the drawings, reference numbers may be reused to identify similar and/or identical elements.

### DETAILED DESCRIPTION

While battery enclosures according to the present disclosure are shown in the context of electric vehicles, the battery enclosures can be used in stationary applications and/or in other applications.

Battery cells include a stack of anode electrodes, cathode electrodes, and separators that are arranged in a battery cell stack. The battery cell stack is arranged in an enclosure that may be made of metal. For cylindrical and prismatic battery cells, the enclosures are typically made of metal such as aluminum or steel.

The melting temperature of steel is about 2.5 times higher than the melting temperature of aluminum. Using steel to manufacture the enclosures helps to maintain the integrity of the enclosure during thermal runaway events when the temperature of the enclosure exceeds the melting temperature of aluminum.

Sidewall failures of steel enclosures may still occur during thermal runaway. For example, sidewall failures may occur in battery cells with thin steel walls (e.g., with a thickness in a range from 0.2 mm to 0.3 mm). While the thermal runaway temperatures are usually lower than the melting temperature of steel, the enclosure is prone to rupture due to softening of the steel during thermal runaway when the temperature inside of the battery cell rises above 800° C. The battery enclosure experiences temperatures approximately in the range from 500° C. to 800° C. during thermal runaway. At these high temperatures, mild steel softens, which may trigger side wall rupture (e.g., due to high gas pressure). Sidewall failure can be mitigated by increasing the thickness of walls of the enclosure. However, increasing the thickness of the enclosure reduces gravimetric energy density (Wh/kg) of the battery cells.

The present disclosure relates to an enclosure for cylindrical and prismatic battery cells that is made of a steel alloy that softens more gradually with increased temperature as compared to mild steel. Reduced softening (e.g., allowing more strength to be retained at elevated temperatures) helps to avoid side wall failures.

In some examples, a cold rolled and annealed steel sheet including a nickel coating is used. In some examples, the steel sheet includes carbon in a range from 0.02 to 0.3 wt %, manganese in a range from 0.2 to 2.0 wt %, chromium and molybdenum in a range from 0.5 wt % to 3 wt %, silicon in a range from 0.2 wt % to 2.0 wt %, at least one of niobium, titanium, and/or vanadium in a range from 0.01 wt % to 0.2 wt %, and iron and other materials making up the balance.

In some examples, the enclosure has a martensitic microstructure for room temperature strength and one or more chromium carbides (e.g., fine, and/or undissolved) for elevated temperature properties. In some examples, a carbide fraction is in a range from 1.0 vol. % to 20 vol. % In some examples, the one or more chromium carbides have a size in a range from 50 nm to 500 nm. In some examples, the chromium content of the one or more chromium carbides is in a range from 5 wt % to 52 wt %. In some examples, a minimum tensile strength of the enclosure is 800 MPa at room temperature and 300 MPa at 600° C.

In some examples, a method for manufacturing an enclosure includes roll forming of cold rolled and annealed steel sheet (having the composition described here) into a tube having a rectangular or cylindrical tube shape. Opposite sides of the tube shape are welded to form an open-ended tubular enclosure (e.g., using high frequency welding or laser welding).

The tubular enclosure is rapidly austenitized using induction heating in a temperature range from 900° C. to 950° C. After heating, the tubular enclosure is quenched (using air, water, or a cooled die) to room temperature to form a martensitic microstructure with a fine dispersion of the one or more chromium carbides for strength. After induction heating and quenching, the bottom portion of the enclosure is welded to one end of the tubular enclosure.

The battery enclosures described herein reduce cost as compared to aluminum enclosures currently used in prismatic cells. The steel enclosures are lighter due to the relatively thinner steel walls. The enclosures also improve safety due to enhanced elevated-temperature strength. The elevated strength suppresses side-wall ruptures to allow extra time for pressure to release during a thermal event.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26. The A anode electrodes 40-1, 40-2, . . . , and 40-A include anode active material layers 42 arranged on one or both sides of the anode current collectors 46. In some examples, the A anode electrodes 40 and the C cathode electrodes 20 exchange lithium ions during charging/discharging.

In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

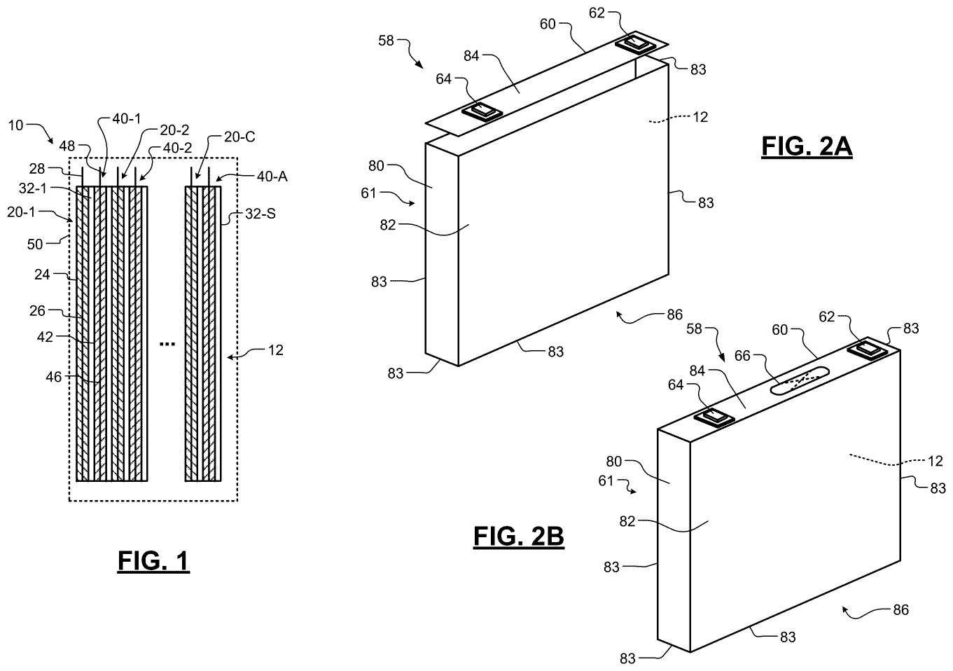

Referring now to FIGS. 2A and 2B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open-ended rectangular prism. In some examples, the enclosure 60 includes a lid portion 84 and a bottom portion 86. In other examples, the bottom portion 86 is attached after the enclosure 60 is formed. Edges 83 are arranged between the sides 80 and 82, the sides 80 and 82 and a lid portion 84, the sides 80 and 82 and the bottom portion 86.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell stack 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

Referring now to FIG. 3, a cylindrical battery cell 110 includes a tubular enclosure 114, a lid portion 118 including a positive terminal 120, and a bottom portion 122. A battery cell stack 126 (e.g., a jellyroll) is arranged in the tubular enclosure 114. External tabs 128 and 132 connect cathode and anode electrodes to the positive terminal 120 and the negative terminal (e.g., on the bottom portion 122).

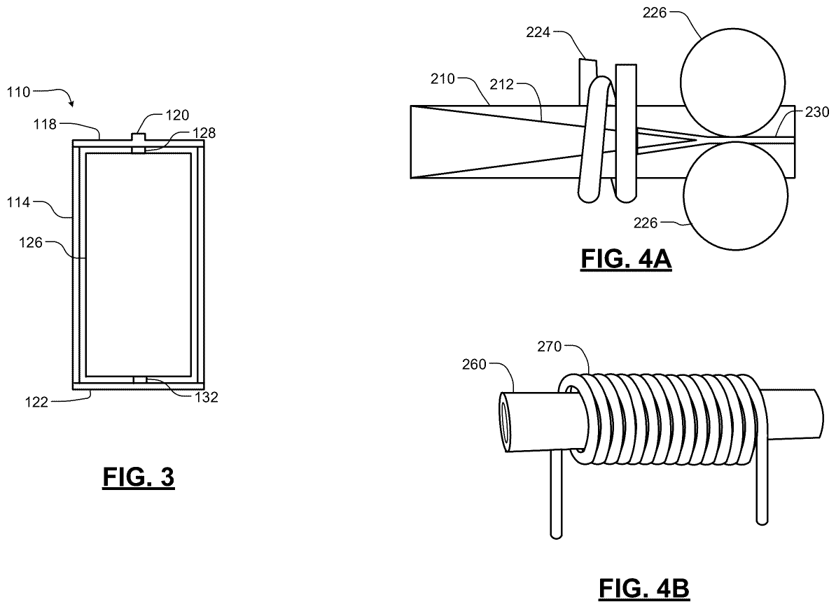

Referring now to FIGS. 4A and 4B, the steel sheet is rolled or formed into a tube 210 (e.g., having an open-ended cylindrical or prismatic shape), a seam is welded, and the tube 210 is hardened. In FIG. 4A, during induction welding of the tube 210, current flows through an inductive coil 224 that is wound around the tube 210. The current generates a time-varying magnetic field that heats the tube 210. Weld rollers 226 press opposite sides 212 of the tube 210 together to form a seam weld 230 that encloses opposite sides of the tube 210.

In FIG. 4B, after seam welding, the welded tube 260 is hardened. For example, the welded tube 260 is inductively heated by an inductive coil 270 wound around the welded tube 260. The welded tube 260 is heated to a predetermined temperature in a range from 900° C. to 950° C. After heating, the welded tube 260 is quenched (e.g., using air, water, or a cooled die) to room temperature.

In some examples, roll forming is conducted using cold rolled and annealed steel with high formability. In some examples, the cold rolled and annealed steel sheet includes an outer coating such as pure nickel.

In some examples, the cold rolled and annealed steel sheet has a lean alloy composition including carbon in a range from 0.02 wt % to 0.3 wt %, manganese in a range from 0.2 wt % to 2.0 wt %, at least one of chromium and molybdenum in a range from 0.5 wt % to 3.0 wt %, silicon in a range from 0.2 wt % to 2.0 wt %, at least one of niobium, titanium, and vanadium in a range from 0.01 wt % to 0.2 wt %, and iron (and optionally other materials making up the balance).

In some examples, the enclosure has a martensitic microstructure for room temperature strength and one or more chromium carbides for elevated temperature properties. In some examples, a carbide fraction is between 1.0 vol. % to 20 vol. %. In some examples, particles of the chromium carbides have a size in a range from 50 nm to 500 nm. In some examples, the chromium content of carbides is between 5 wt % to 52 wt %.

In some examples, a weld seam of the welded tube has a hardness difference that is less than 50 HV (Vickers Pyramid Number) between the weld and bulk steel. In some examples, the strength of the weld seam is as high as the strength of the bulk steel. In some examples, the enclosure has high strength at room temperature. In some examples, a minimum tensile strength of the enclosure is 800 MPa at room temperature and 300 MPa at 600° C. In some examples, the enclosure has strength in a range from 800 MPa to 2 GPa at room temperature. In some examples, the enclosure has strength in a range from 1200 MPa to 2 GPa at room temperature. In some examples, the enclosure has strength in a range from 1500 MPa to 2 GPa at room temperature.

In some examples, the enclosure can operate at elevated temperatures without significant loss of strength. In some examples, the steel comprises Cr/Mo-rich alloy carbides (e.g., with a size in a range from 50 nm to 500 nm) for strengthening at high temperatures. Cr and/or Mo are added for hardenability which allows the use of air (providing a slower cooling rate) as a quenching media instead of water to minimize distortion. In some examples, the lean alloy composition maintains overall thermal conductivity >30 W/mK.

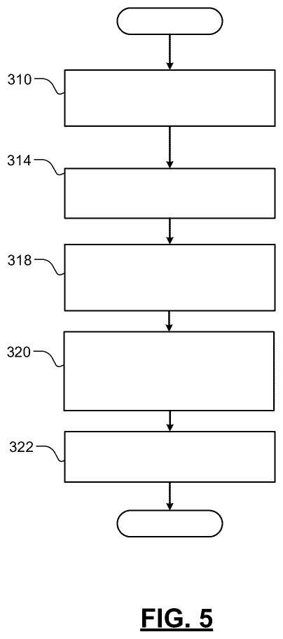

Referring now to FIG. 5, a method for manufacturing a battery enclosure is shown. At 310, cold rolled and annealed steel sheet is rolled and/or formed into a cylindrical or prismatic tube. At 314, edges of tube are welded to form a weld seam of a tubular enclosure.

At 318, the tubular enclosure is hardened. In some examples, the tubular enclosure is austenitized by heating the tubular enclosure using inductive heating and soaking for a predetermined soak period. In some examples, the predetermined soak period is in a range from 1 s to 60 s. In some examples, the predetermined soak period is in a range from 4 s to 20 s. At 320, the tubular enclosure quenched after rapid heating to form a martensitic microstructure with fine dispersion of chromium carbides. At 322, a bottom portion of the enclosure is mechanically crimped, brazed, or welded (e.g., high frequency or laser welded) to one end of the tubular enclosure. Subsequently, the battery cell stack is arranged in the enclosure, terminals are connected, and the lid portion is attached.

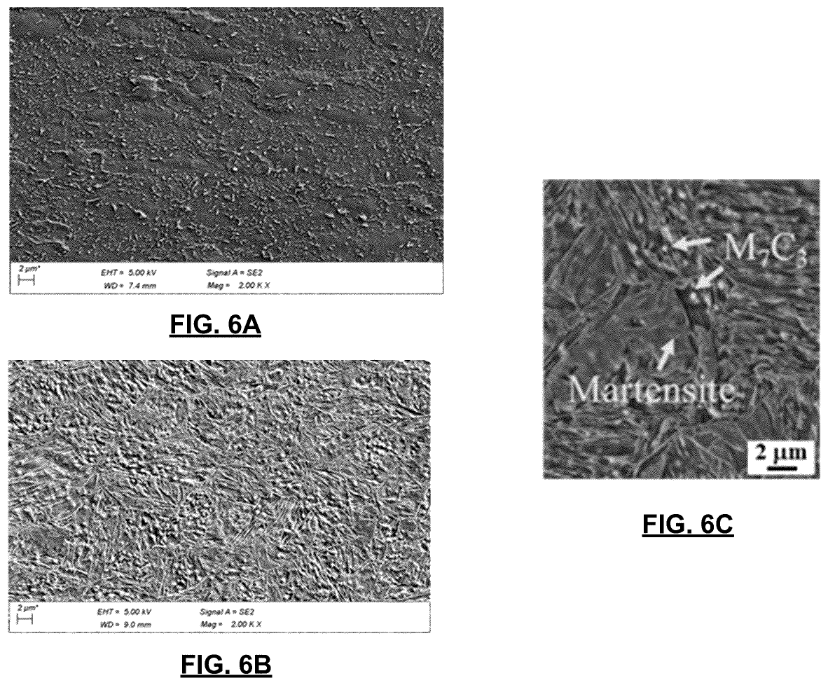

Referring now to FIGS. 6A to 6C, scanning electron microscope images of the tubular enclosure are shown during manufacturing. In FIG. 6A, the tubular enclosure is shown before hardening (˜600 MPa ultimate strength). In FIG. 6B, the tubular enclosure is shown after hardening (˜1700 MPa ultimate strength). In FIG. 6C, the steel includes Cr-rich M₇C₃ carbides to improve high temperature strength.

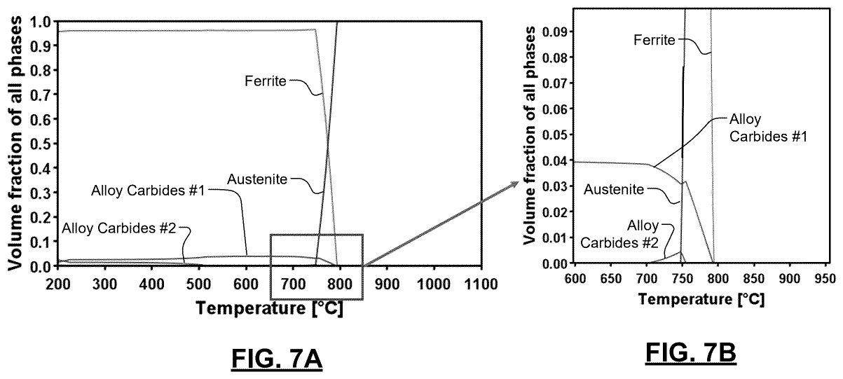

Referring now to FIGS. 7A and 7B, simulations (e.g., made using Thermo-Calc®) show estimated volume fractions of phases as a function of temperature for the enclosure. The simulations indicate that alloy carbides #1 and alloy carbides #2 remain in the matrix until elevated temperatures of 800° C.

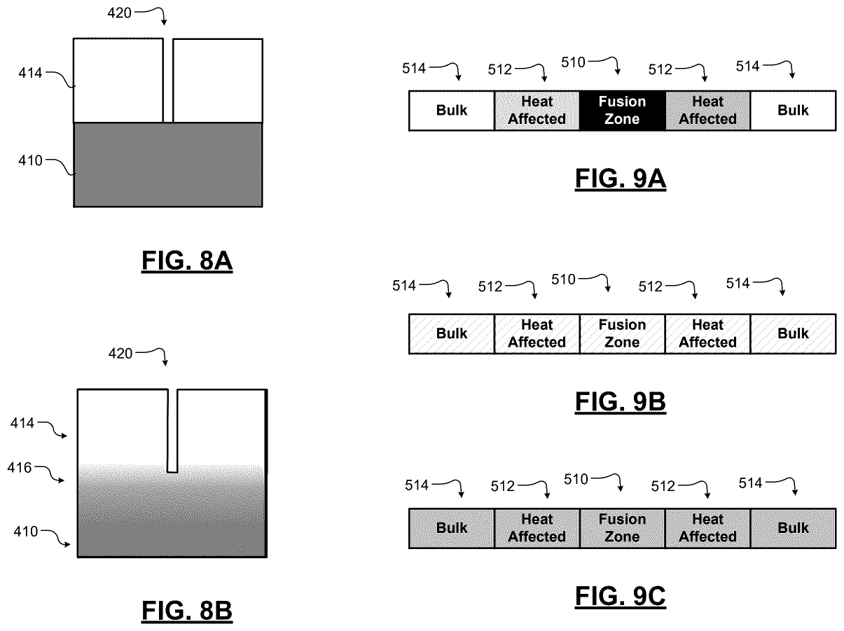

Referring now to FIGS. 8A and 8B, the steel 410 may include a coating 414 (e.g., such as nickel) on an outer surface thereof to improve corrosion resistance to electrolyte during use. In FIG. 8A, pin holes in the coating 414 may occur. Without the inductive heating and hardening steps described herein, the electrolyte contacts the steel 410 and causes corrosion. After inductive heating and hardening steps, the coating 414 diffuses into the steel 410 (as shown in FIG. 8B) to form an alloy diffusion layer 416 (e.g., iron-nickel alloy) near an interface therebetween. The iron-nickel diffusion layer provides increased corrosion resistance in coating pin holes 420. Therefore, hardening of the steel 410 improves coating coherence and corrosion resistance (e.g., especially at coating pin holes 420).

Referring now to FIGS. 9A to 9C, improvements in weld quality are illustrated after welding of the tubular enclosure, after heating to austenitization, and after quench hardening, respectively. After welding (shown in FIG. 9A), material in the middle of the weld is fusion hardened at 510. Areas adjacent to the weld are heat affected (e.g., softened due to heat) at 512. Outer areas at 514 include bulk steel have small or no change in hardness. In FIG. 9B, the tubular enclosure is heated to austenitization. After quench hardening (shown in FIG. 9C), the hardness of the tubular enclosure is more uniform as compared to FIG. 9A. Austenitization before quench hardening improves the microstructure of weld seam, including the fusion zone and the heat affected zone, which results in improved toughness and hardness.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

1. A method for manufacturing a tubular enclosure for a battery cell, comprising:
roll forming a sheet of steel into a tubular body,
wherein the steel comprises:
carbon in a range from 0.02 to 0.3 wt %,
manganese in a range from 0.2 to 2.0 wt %,
at least one of chromium and molybdenum in a range from 0.5 wt % to 3.0 wt %,
silicon in a range from 0.2 wt % to 2.0 wt %,
at least one of niobium, titanium, and vanadium in a range from 0.01 wt % to 0.2 wt %, and
iron;
welding sides of the tubular body to form a weld seam;
heating the tubular body to a temperature in a range from 900° C. to 950° C.; and
quenching the tubular body.

2. The method of claim 1, further comprising attaching a bottom portion onto one end of the tubular body.

3. The method of claim 1, wherein the tubular body has a martensite microstructure after the quenching.

4. The method of claim 1, wherein the tubular body includes one or more chromium carbides having a size in a range from 50 nm to 500 nm.

5. The method of claim 4, wherein a fraction of the one or more chromium carbides in the tubular body is in a range from 1.0 vol % to 20 vol % after the quenching.

6. The method of claim 4, wherein a weight of the one or more chromium carbides in the tubular body is in a range from 5 wt % to 52 wt % after the quenching.

7. The method of claim 1, wherein the tubular body has a minimum tensile strength of 800 MPa at room temperature and a minimum tensile strength of 300 MPa at 600° C.

8. The method of claim 1, wherein the tubular enclosure has one of a cylindrical cross section and a prismatic cross section.

9. The method of claim 1, wherein a maximum hardness difference between a weld seam and steel of the tubular body that was not heat affected during welding is less than 50 HV.

10. The method of claim 1, wherein the steel includes a nickel coating and an iron-nickel alloy layer arranged between the nickel coating and the steel after the quenching.

11. A tubular enclosure for a battery cell, comprising:
a tubular body made of a steel and including a seam weld,
wherein the steel comprises:
carbon in a range from 0.02 to 0.3 wt %;
manganese in a range from 0.2 to 2.0 wt %;
at least one of chromium and molybdenum in a range from 0.5 wt % to 3.0 wt %;
silicon in a range from 0.2 wt % to 2.0 wt %;
at least one of niobium, titanium, and vanadium in a range from 0.01 wt % to 0.2 wt %; and
iron; and
a bottom portion attached to one end of the tubular body.

12. The tubular enclosure of claim 11, wherein the tubular body has a martensite microstructure after austenitizing and quenching.

13. The tubular enclosure of claim 12, wherein the tubular body includes one or more chromium carbides having a size in a range from 50 nm to 500 nm after the austenitizing and quenching.

14. The tubular enclosure of claim 13, wherein a fraction of the one or more chromium carbides in the tubular body is in a range from 1.0 vol % to 20 vol % after the austenitizing and quenching.

15. The tubular enclosure of claim 13, wherein a weight of the one or more chromium carbides in the tubular body is in a range from 5 wt % to 52 wt % after the austenitizing and quenching.

16. The tubular enclosure of claim 11, wherein the tubular body has a minimum tensile strength of 800 MPa at room temperature and a minimum tensile strength of 300 MPa at 600° C.

17. The tubular enclosure of claim 13, wherein the tubular enclosure has a prismatic cross section.

18. The tubular enclosure of claim 11, wherein the tubular enclosure has a cylindrical cross section.

19. The tubular enclosure of claim 11, wherein a maximum hardness difference between the seam weld and steel of the tubular body that was not heat affected during welding is less than 50 HV.

20. The tubular enclosure of claim 11, wherein the steel includes a nickel coating and an iron-nickel diffusion layer arranged between the nickel coating and the steel.
